(19) United States
(12) Patent Application Publication
(10) Pub. No.: US 2007/0081107 A1
(43) Pub. Date: Apr. 12, 2007

(54) Active matrix display device and method of producing the same

(75) Inventors: Hjalmar E.A. Huitema, Veldhoven (NL); Roel Penterman, Eindhoven (NL); Joost P.A. Vogels, Leende (NL); Stephen I. Klink, Breda (NL); Hendrik De Koning, Well (NL); Dirk J. Broer, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/578,061

(22) PCT Filed: Nov. 1, 2004
(86) PCT No.: PCT/IB04/52252

§ 371 Date: May 2, 2006

(30) Foreign Application Priority Data
Nov. 5, 2003 (GB) 0325747.4

(51) Int. Cl. G02F 1/136

(52) U.S. Cl. 349/42

(57) ABSTRACT

An active matrix display device has an optical layer (7,9,11) comprising a mixture of an electro-optical material and a polymer precursor. An upper surface of the active plate comprises an array of wells (70) such that the upper surface has higher (72) and lower regions, and the optical layer mixture is provided over the active plate. The optical layer is exposed to a stimulus for polymerizing the polymer precursor into a polymer layer constituted by a top surface (9) and by side walls (11), thereby enclosing the electro-optical material between the polymerized material and the active plate to define display pixels. Enclosed bodies of electro-optical material defining display pixels are thus provided over the lower regions. This method uses the processing of the active plate to define wells (70) which provide a height difference which can be used to provide alignment of enclosed display pixels cells. This avoids the need for an alignment mask during the deposition and exposure of the optical layer. In an embodiment of the invention,a layer (74) having affinity to the polymer precursor is provided on the higher regions in a stamping step before exposing the otical layer to the stilus.

The present invention relates to active matrix display devices and a method of producing such devices. In particular, the invention relates to a display having a stratified light modulation layer.

A number of different types of display device are available, such as electrophoretic displays, like e-ink devices, and liquid crystal displays (LCDs). LCDs have become increasingly popular over recent years. LCDs can be found in a wide range of products, from handheld electronic devices like personal digital assistants and mobile phones to computer monitors and television sets.

Currently, significant efforts are being made to enable the dimensions of these display devices to be increased. The traditional production method for LCDs is to deposit a liquid crystal material between two glass or polymer plates. Increasing the size of the substrate panels makes them difficult to handle. In addition, large substrate panels require large and heavy machinery, which makes the production process costly.

European patent application EP 1065553 A1 discloses an alternative method for producing a liquid crystal display. A layer of a mixture of a polymer precursor and a liquid crystal (LC) material is deposited on a transparent substrate carrying an orientation layer, after which the mixture is exposed to UV light in a photolithographic step. In this step, the polymer precursor is polymerized to form sidewalls between the desired pixels of the LCD. Subsequently, the rest of the mixture is exposed to UV light. This triggers a phase separation in which the polymer precursor is polymerized to form a continuous top layer on top of the polymer sidewalls, and in which the LC material is trapped between the polymer top layer, the polymer sidewalls and the substrate, thus forming a plurality of pixels on the substrate. The polymer top layer serves as a second substrate.

This process allows the layer of a mixture of a polymer precursor and a liquid crystal (LC) to be applied by a spin coating process, which simplifies and reduces the cost of the fabrication process. It also enables this layer to be thinner than the conventional LC layer. The polymerization process forms cavities for each liquid crystal pixel, so that pixel alignment is provided and the body of liquid crystal for each pixel is trapped in position.

However, a drawback of this method is that several photolithography steps are required to form the separate LC pixels, and the development and production of masks is costly. These photolithography steps are required in particular to define the polymerized side walls of each pixel. Furthermore, this process requires a number of different UV exposure steps, of different wavelengths and intensities, in order to define side walls which penetrate the full depth of the mixture, and a top shallow surface layer of polymerized material.

The applicant has proposed (but not published at the date of filing this application) an alternative process in which a single exposure step is required. In this process, a stamping process is used to selectively deposit a chemically functionalized species over the substrate. This gives parts of the substrate a high affinity for the polymerizable material of the mixture (in particular a high affinity to partially polymerized material). During a single UV irradiation step, the high affinity regions result in the polymerization concentrating at those regions of the mixture. When the mixture is partially polymerized, non-polymerized liquid tends to concentrate at the spaces between the high affinity regions, thereby defining the liquid crystal cells, whereas the polymerized parts of the mixture concentrate at the top surface (where the irradiation intensity is greatest) and at the high affinity regions, thereby defining side walls.

This process simplifies the UV irradiation process, but still requires accurate alignment of the stamp used to deposit the functionalized species.

According to the present invention, there is provided a method of producing an active matrix display device having an optical layer comprising a mixture of an electro-optical material and a polymer precursor, the method comprising:

producing an active plate comprising a substrate carrying an array of pixel circuits, each pixel circuit comprising a thin film transistor, wherein the active plate comprises a plurality of thin film layers defining the transistors, and wherein an upper surface of the active plate comprises an array of wells such that the upper surface has higher and lower regions;

providing the optical layer mixture of an electro-optical material and a polymer precursor over the active plate; and

exposing the optical layer to a stimulus for polymerizing the polymer precursor into a discrete polymer surface layer, thereby enclosing the electro-optical material between the polymerized material and the active plate to define display pixels, and wherein enclosed bodies of electro-optical material defining display pixels are provided over the lower regions.

This method uses the processing of the active plate to define wells which provide a height difference which can be used to provide alignment of the enclosed display pixels cells. This avoids the need for an alignment mask during the deposition and exposure of the optical layer.

Preferably, the array of wells is defined by (at least) a passivation layer forming the top layer of the active plate. This layer is already required by the active plate and is typically already patterned. Thus, no additional patterning steps are required. The passivation layer may for example comprise silicon nitride, having thickness of 0.5-1.5 micrometers. The wells are formed by at least partial removal of the silicon nitride layer.

In one version of the method, after producing the active plate, the higher regions are coated with an increased affinity layer for providing an increased affinity for the polymerizable material of the optical layer, and exposing the optical layer to a stimulus also forms side layers over the increased affinity layer. This process enables a single exposure operation to define side walls and a top wall for enclosing the display pixel. The position of the display pixel is fixed by the side walls, which are in turn determined by the higher regions of the active plate upper surface. The coating may be performed by stamping the increased affinity layer onto the higher regions of the active plate. This stamping can be carried out using a non-patterned stamp, or using a coarsely patterned stamp, but in either case very accurate stamp alignment is not required.

The high affinity layer preferably comprises a layer functionalized with chemically reactive groups.

In another version of the method, the array of wells is defined into a photoresist layer on top of the passivation layer. This enables deep wells to be formed, which can enclose the display pixel cells, thereby avoiding the. need for polymerized side walls. For example, the thickness of the photoresist layer can be 5-15 micrometers.

The resist layer can also comprise a material for providing an increased affinity for the polymerizable material of the optical layer. Thus, in the areas of the resist, layer that remain (i.e. not the wells) exposing the optical layer to a stimulus also forms side walls over the increased affinity layer. Thus, the material does not need to accurately fill the defined wells.

A. liquid crystal alignment layer can be provided over the active plate, for example applied by spincoating or printing.

The electro-optical material preferably comprises a liquid crystal material.

The invention also provides an active matrix display device having an optical layer comprising a mixture of an electro-optical material and a polymer precursor, comprising:

an active plate comprising a substrate carrying an array of pixel circuits, each pixel circuit comprising a thin film transistor, wherein the active plate comprises a plurality of thin film layers defining the transistors, and wherein an upper surface of the active plate comprises a passivation layer in which is defined an array of wells; and

an array of display pixels comprising electro-optical material enclosed between polymerized material of the mixture and the active plate, wherein the enclosed electro-optical material display pixels are aligned with respect to the wells.

Again, the higher regions can be at least partially coated with an increased affinity layer for providing an increased affinity for the polymerizable material of the optical layer, and wherein the polymerized material defines side layers over the increased affinity layer. Alternatively, the display cells can be enclosed by the side walls of the wells.

Examples of the invention will now be described in detail with reference to the accompanying drawings, in which:

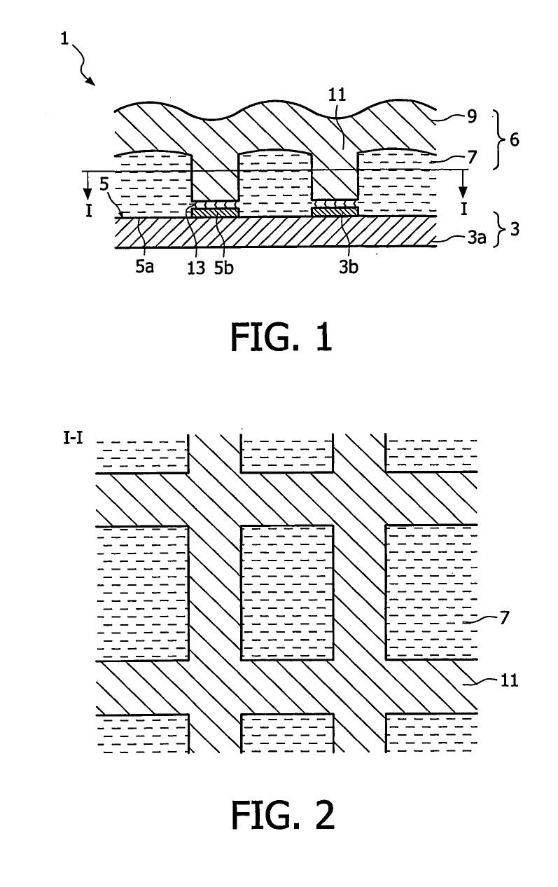

FIG. 1 is used to explain one LCD manufacturing process proposed by the applicant, but not forming part of the invention;

FIG. 2 shows one pixel of the FIG. 1 display in plan view;

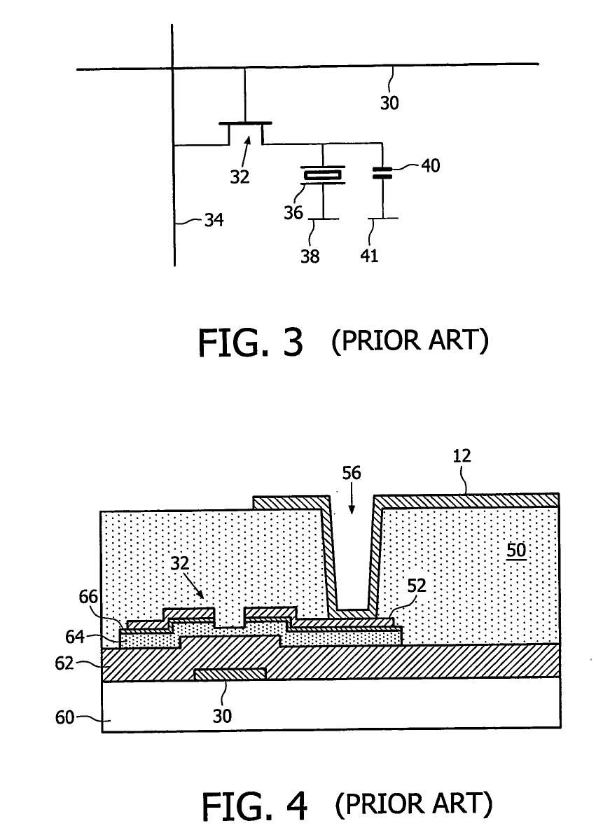

FIG. 3 shows the known pixel circuitry for an active matrix LCD pixel;

FIG. 4 shows the TFT of the pixel circuit of FIG. 3 in cross section;

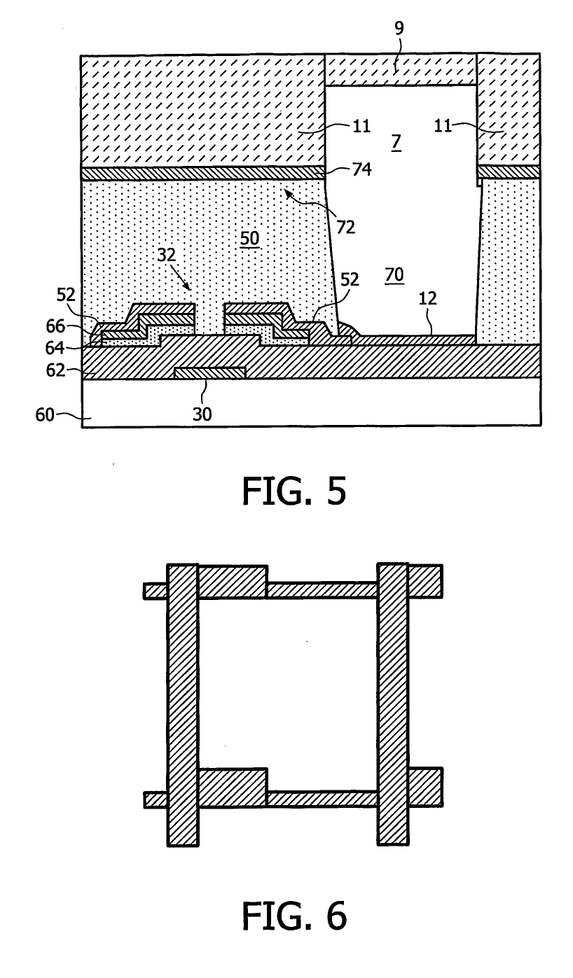

FIG. 5 shows a first pixel arrangement of the invention;

FIG. 6 shows the pixel layout of FIG. 5 in plan view;

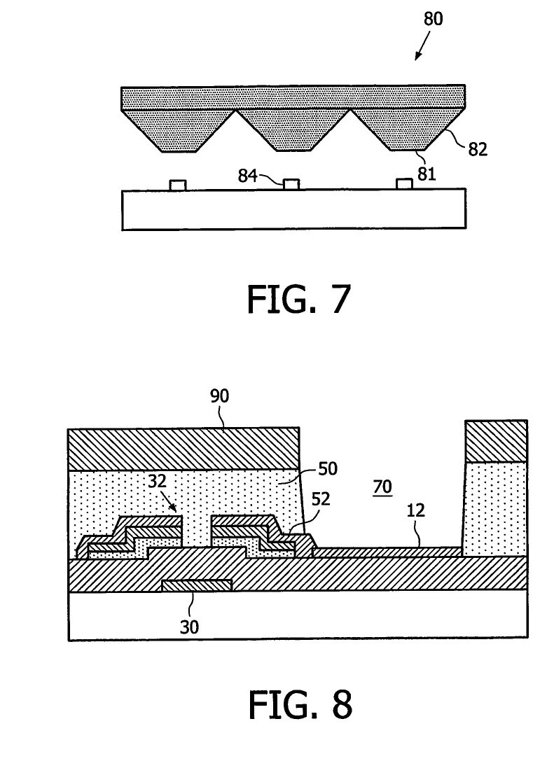

FIG. 7 shows a stamp that can be used in the manufacture of the device of FIG. 5; FIG. 8 shows a second pixel arrangement of the invention; and

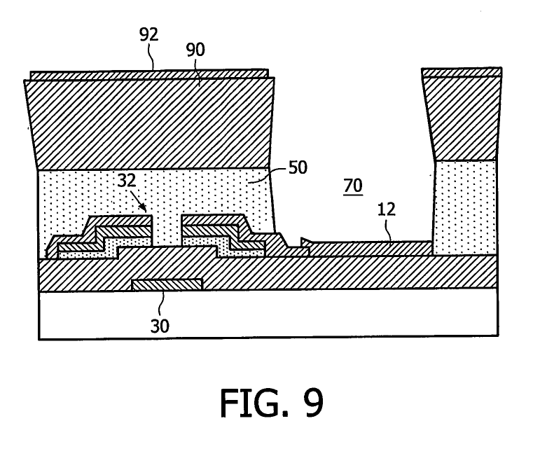

FIG. 9 shows a third pixel arrangement of the invention.

FIG. 1 shows in cross section a display device 1 which has been proposed by the applicant, but has not yet been published. The display uses polymeric stratified-phase-separated composite 6. This comprises a liquid layer 7 which functions in the same way as a conventional liquid crystal layer, and portions 9, 11 of polymerized material. These polymerized material portions provide a covering layer 9 as well as side walls 11, which extend down to the underlying substrate 3. These side walls 11 and the top layer 9. together define encapsulated areas within which portions of liquid crystal material 7 are trapped, and these define individual display pixels.

The substrate comprises a base film 3a and a separate patterned layer 3b. The surface of the patterned layer 3b provides regions 5b of high affinity for the polymerizable material which forms the side walls 11. The regions of the base film 32 which are exposed to the liquid layer 7 provide regions of low affinity 5a.

To render the surface of the patterned layer 3b with a high affinity to the polymerizable material, the surface is functionalized with chemically reactive groups. These groups are capable of reacting with the polymerizable material from which the side walls 11 are obtained to form covalent bonds. These bonds are shown schematically in FIG. 1 by reference 13.

In particular, the high affinity regions 5b are capable of forming covalent bonds with partially polymerized material, and the low affinity regions 5a are not capable of doing so. Covalent bonds are not the only possibility of achieving this. Other possibilities include a substrate surface with polar regions in one area and apolar regions in another area, in combination with either polar or apolar polymerizable material. Similarly, ionic regions and non-ionic regions, or positively charged ionic regions and negatively charged ionic regions in combination with electrically charged polymerizable material may also be used.

The phase-separation of the material 6 is preferably induced by UV radiation. It is, however, also possible to use solvent or temperature induced phase-separable material.

In the preferred example, the layer of material 6 is subjected to a flood exposure with UV light. The phase-separable material absorbs the UV radiation, and an intensity gradient is set up in the material transverse to the layer thickness. The absorption of radiation by the layer is selected such that a significant amount of radiation is able to reach the substrate surface 5, in particular the high affinity regions 5b.

Initially, the UV irradiation induces polymerization of the material to form partially polymerized material, which is still fully miscible within the liquid of the material. Prior to phase separation, the level of polymerization is substantially constant throughout the layer at each penetration depth, but in directions transverse to the layer, the intensity gradient gives rise to greater levels of polymerization nearer the UV source. This gradient causes migration of partially polymerized material towards the radiation source, and migration of liquid (non-polymerized) away from the radiation source. Furthermore, adjacent the regions of high affinity 5b, the partially polymerized material reacts with the chemically reactive groups on the surface of the high affinity regions 5b to form the covalent bonds 13, thus adheri ng the partially polymerized material to the substrate surface and preventing migration of the polymerized material.

As the polymerization proceeds, the polymerized material is no longer miscible within the liquid, and this occurs at the beginning of phase-separation. At the end of the process, phase-separation occurs in the regions adjacent the high affinity regions 5b thereby forming the side walls 11, and any liquid becomes encapsulated between these side walls and the top surface layer 9.

Thus, the structure shown in FIG. 1 can be produced with a single UV irradiation step.

The thickness of the layer of polymerized material 9 is typically between 1 and 200 micrometers, or more preferably 10 to 40 micrometers. The liquid film 7 forming the display pixels may have a thickness of around 1 millimetre, although this thickness may be significantly less, for example 200 micrometers or less. A liquid crystal layer preferably has a thickness of 1-10 micrometers.

The use of a stratified-phase-separated composite enables the production of a liquid crystal display which is thin and flexible while maintaining mechanical robustness, and which has reduced production costs.

The polymeric stratified-phase-separated composite is known in the art, as well as the method of producing such materials. By way of example, reference is made to U.S. Pat. No. 6,486,932, WO 02/42832, WO 02/48281, WO 02/48282 and WO 02/48783.

FIG. 2 shows schematically a top view of the display of FIG. 1 along the line I-I. As shown, the side walls 11 form a rectangular grid of walls providing enclosed spaces for the liquid crystal layer 7.

The process described above simplifies the manufacturing process and reduces the manufacturing cost. One disadvantage, however, is that a patterned deposition process is required to form the patterned layer 3b which is processed to form the high affinity regions 5b. This process may be a photolithographic process, or else a stamping process may be used. In either case, accurate alignment is required, in particular so that the layer 3b is aligned correctly with respect to the circuit elements of the individual pixels.

Although not shown in FIG. 1, the substrate 3 will also carry this pixel circuitry and will comprise many more layers than those shown in FIG. 1. The substrate 3 will in practice comprise the active plate of an active matrix display.

The invention modifies the processing of the active plate 3 to enable the encapsulated liquid crystal cells 7 to be formed by a self-aligned process. In particular, an upper surface of the active plate is provided with an array of wells, and the well positions subsequently determine the positions of the encapsulated display pixel cells 7.

Before describing the invention, an example of active plate for an active matrix liquid crystal display will first be described.

FIG. 3 shows the electrical components which make up the pixel circuit for each pixel. A row conductor 30 is connected to the gate of a TFT 32, and a column electrode 34 is coupled to the source. The liquid crystal material provided over the pixel effectively defines a liquid crystal cell 36 which extends between the drain of the transistor 32 and a common ground plane 38. The ground plane 38 is defined by the passive plate and the other terminal of the LC cell is defined by pixel electrodes 12. A pixel storage capacitor 40 is connected between the drain of the transistor 32 and the row conductor associated with an adjacent row of pixels or else to a separate line 41.

FIG. 4 shows a cross-section through the TFT of one example of known active plate for a transmissive display.

A metal layer 52 is used for the source and drain, whereas a transmissive conductive material is needed for the pixel electrode 12, such as ITO.

The pixel electrode 12 is provided over a passivation layer 50 and contacts the drain 52 of the TFT 32 through a contact hole 56 in the layer 50. The passivation, layer is typically 100 nm to 500 nm thick, but can be thicker if required. In an alternative Field Shielded Pixel (FSP) design, a thicker passivation layer is used, for example 1 to 3 micrometers of polyimide. In a FSP design, the pixel electrodes 12 can overlap the row and column conductors 30,34, so that there is no gap between the row and column conductors and the pixel electrodes, which would otherwise need to be shielded. This results in a high aperture pixel.

In more detail, the active plate structure of FIG. 4 comprises a glass substrate 60, a gate metal layer 30 (which forms also the row conductors), and a silicon nitride gate insulator 62. The transistor body is defined by an amorphous silicon layer 64 and an n⁺amorphous silicon contact layer 66.

A single source-drain metalization defines the source and drain 52.

The known method of forming a stratified liquid crystal display of EP 1065553 can be applied to the active plate such as shown in FIG. 4, and the active plate of FIG. 4 can also be used for the process proposed by the applicant as described above with reference to FIGS. 1 and 2.

As shown in FIG. 4, the silicon nitride passivation layer 50 (which may instead be a polymer) is patterned to define the contact vias 56. The invention uses this patterning process to provide self alignment of stratified display cells;

FIG. 5 shows a modification to the active plate of FIG. 4 to implement the invention.

As shown, the passivation layer 50 is removed to form a well 70. This can be achieved simply by changing the processing of the last layer in active plate stack. This well 70 corresponds to the desired pixel electrode shape.

The removal of the silicon nitride passivation layer (or any other passivation layer) enables a height difference to be created, as shown in FIG. 5. This can enable a stamping process to be used to selectively deposit a reactive species on the higher parts 72 of the active plate. As shown in FIG. 5, the pixel electrode 12 is deposited in the base of the well 70, and the reactive species 74 is provided on the higher parts of the silicon nitride layer 50.

Typically, a thickness of the silicon nitride layer of 500 nm will result in the silicon nitride forming an upper surface which extends above all other parts of the active plate. The silicon nitride layer can be made thicker, for example around 1 micrometer in order to increase further these height differences.

The retained part of the passivation layer 50 can be designed in an appropriate shape to form the side walls which will subsequently enclose liquid crystal material.

The height difference enables the functionalized material to be deposited on the higher parts of the passivation layer 50 without the need of a patterned stamp. This removes the difficult step of exact alignment of a stamp with respect to the pixel pads reactive plate. In this way, the stratified liquid crystal process can be applied in a self-aligned way without the need of any additional mask step.

FIG. 6 shows in plan view one complete pixel. The bold hatched area represents the remaining passivation layer which is used to form the polymerized side walls which separate the liquid crystal pixel cells in. two different areas.

Prior to the deposition of the functionalized species by the stamping process, an alignment layer is currently deposited by spin coating. If the height differences are not too large, spin coating can still be employed, although so-called flexoprinting may be more appropriate, as this is less sensitive to height differences. The alignment layer is typically polyimide, and is not shown in the drawings. However, this will cover the exposed upper surface of the active plate. The height differences can also cause problems during rubbing of the polyimide. A contactless alignment method, such as ion beam alignment or photoalignment can then be used.

When the functionalized species is applied by the stamping process, a stiff rubber stamp with no height differences can be used. This may comprise a rubber stamp glued on to a stiff substrate for example an aluminium foil. Alternatively, a more densely cross-linked rubber may be used so hat the stamp is much stiffer than the PDMS material that is currently used. It is also possible to provide silicon nitride islands within the pixel area to act as intermediate supports.

FIG. 7 shows how a coarsely patterned PDMS stamp 80 may be employed. The stamp has raised portions 81 which carry the functionalized species and recesses 82 which are provided over the pixel areas. The raised portions 81 are substantially wider than the side walls 84 defined by the passivation layer, so that the alignment of the coarsely patterned stamp is not critical. The use of a coarsely patterned stamp in this way enables the height differences of the active plate to be maintained at relatively low levels.

The subsequent deposition and UV treatment of the liquid crystal and polymer precursor mixture can be applied in the same way as described with reference to FIG. 1. This forms the side walls 11 and top surface 9 as shown in FIG. 5.

In the example above, the pixel electrode is deposited into a well defined in the passivation layer. In an alternative embodiment, the photo resist layer used to pattern the passivation layer can also be used for pixel alignment.

In this alternative embodiment, the pixel pad is not deposited separately, but the area of the drain is expanded and structured to act as pixel pad. This is shown in FIG. 8, in which the same references are used as in FIG. 5 for the same components. Reference 90 is the photo resist layer. The resist layer 90 that is used to pattern the passivation layer 50 is not stripped. This enhances the height differences on the active plate.

This is a common configuration for amorphous silicon displays that are used in the reflective mode, since the drain is usually composed of a non-transparent metal. However, a thin metal pixel pad will not only be reflective but also transmissive, so in principle could also be used in transmissive/transflective displays.

The modification shown can be processed further as described above, so that a functionalized species can be stamped on to the raised proud parts of the photo resist layer, again without the need for a patterned stamp. The increased height differences simplify the stamping of the reactive species on top with an unpatterned stamp.

However, the increased height differences can even be used to form the side walls needed for the stratified process. The resulting array of photo resist walls may be as high as 10 μm. A wall height of around 5 micrometers or more will typically be sufficient for the processing steps that are needed to form the polymer walls during stratified LC processing to be omitted. In this way, the stratified LC process can be applied in a self-aligned way without the need of an additional mask step. This avoids the need for the stamping step as no polymer side walls are required.

This embodiment can also avoid the need for the functionalized species to be deposited, even when polymerized side walls are required. In particular, the photo resist on top of the passivation layer can be modified in such a way that it reacts with the polymer of the stratified layer itself. In this way, the,photo resist layer has two functions. It serves as a standard photo resist that protects the underlying passivation layer during etching. In addition, it contains the reactive groups that allow the polymer. layer formed during the stratification process to bind to the photo resist layer. In this way the stamping step can be eliminated.

This process can be applied to amorphous silicon or poly-silicon processes, as the both use the same silicon nitride passivation layer.

In another embodiment, the pattern of the silicon nitride passivation layer (or any other passivation layer) is not only used for the stratification process, but also for deposition of the ITO pixel pad. This results in a transmissive active plate.

FIG. 9 shows an alternative to FIG. 8 in which the resist layer 90 that is used to pattern the passivation layer 50 is not stripped and has a so-called ‘paddo’ shape (as used in PolyLED displays). This creates cups for deposition of the ITO pixel pads 12. The ITO layer 12 will not be continuous because of the overhangs of the resist layer 90.

The shadow effect results in an ITO pixel pad 12 and unused ITO 92 on top of the resist layer 90. In this arrangement, two mask steps are eliminated, as structuring of the ITO pixel pads is not necessary. Subsequent processing steps are as described above. Again, application of a functionalized species on top of the unused ITO 92 may or may got be required depending on the height differences, and therefore whether or not the liquid crystal cells will be fully enclosed within the wells.

The invention is applicable to an active matrix display using polymer electronics. The preferred arrangement of layers for the active plate using polymer electronics is based on gold electrodes, an organic gate dielectric layer (a photo resist) and a “HPR” passivation layer (also a photo resist).

The passivation layer can again be used to enable unpatterned stamping of the functionalized species, or to avoid the need for the functionalized species at all.

The invention requires only modification to the structuring of the final passivation layer for the amorphous silicon, the polysilicon or polymer electronics processes.

As mentioned above, the LC and precursor mixture is already known in the art. By way of example, a suitable composition is as follows:

50 weight percent (wt %) of a liquid crystal mixture, for instance the mixture E7, which is marketed by Merck;

44.5 weight percent (wt %) of photo-polymerizable isobornylmethacrylate (supplied by Sartomer); and

5 weight percent (wt %) of a stilbene dimethacrylate dye:

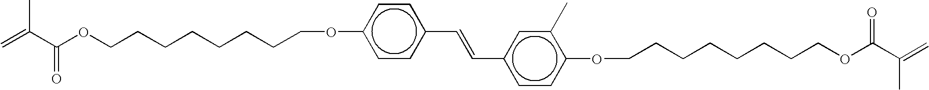

The synthesis of this has been disclosed in PCT patent application WO 02/42382 and which is hereby incorporated by reference, the two acrylates being the polymer precursor; and

0.5 weight percent (wt %) of benzildimethylketal, which is marketed by Ciba-Geigy under the trade name Irgacure 651.

The UV exposure of this material to provide the polymerization may for example involve exposing the layer to UV light with a light intensity of around 0.1 mW/Cm² for 30 minutes at 40° C.

The inclusion of a compound having a chromophore strongly absorbing in the UV region of the electromagnetic spectrum, i.e., the stilbene dimethacrylate dye in the example above, causes the desired gradient in the UV intensity through the layer. This effect may be amplified by the UV. absorptions of the other components of the liquid, like the other components of the polymer precursors and the electro-optical materials. Consequently, the polymerization reaction predominantly takes place at the surface facing the UV source.

When other stimuli for triggering the polymerization reaction are used, care has to be taken that the polymerization reaction predominantly takes place at the surface.

Where a high affinity layer is required, this may be deposited with a stamp simultaneously contacting the whole raised part surface of the active plate, or with a stamp that is rolled over the surface of the carrier.

The electronic device 1 of the present invention has particular advantages when the carrier 10 is a flexible carrier.

The invention can be applied to many different display pixel configurations. For example, an IPS (In-Plane Switching) active pate has the drain structured into a comb-shape. The opposite (common) electrode also has a comb shape and is connected to the gate line. The use of metal lines. instead of ITO for transmissive IPS displays is possible (for example when the pixel electrode is to be an extension of the TFT drain as in FIG. 8), as this does not significantly reduce the aperture, because the LC material above the electrodes does not switch in the IPS mode.

It should be noted that the above-mentioned embodiments illustrate rather than limit the invention, and that those skilled in the art will be able to design many alternative embodiments without departing from the scope of the appended claims.

1. A method of producing an active matrix display device having an optical layer (7,9,11) comprising a mixture of an electro-optical material and a polymer precursor, the method comprising:
producing an active plate comprising a substrate (60) carrying an array of pixel circuits, each pixel circuit comprising a thin film transistor (32), wherein the active plate comprises a plurality of thin film layers (30,62,64,66,52) defining the transistors, and wherein an upper surface (50) of the active plate comprises an array of wells (70) such that the upper surface has higher (72) and lower regions;
providing the optical layer mixture of an electro-optical material and a polymer precursor over the active plate; and
exposing the optical layer to a stimulus for polymerizing the polymer precursor into a discrete polymer surface layer (9), thereby enclosing the electro-optical material between the polymerized material and the active plate to define display pixels, and wherein enclosed bodies of electro-optical material defining display pixels are provided over the lower regions.

2. A method as claimed in claim 1, wherein the array of wells is defined by a passivation layer (50) forming part of the top of the active plate.

3. A method as claimed in claim 2, wherein the passivation layer (50) comprises silicon nitride.

4. A method as claimed in claim 3, wherein the thickness of the silicon nitride layer (50) is 0.5-1.5 micrometers, and the wells are formed by at least partial removal of the silicon nitride layer.

5. A method as claimed in claim 1, further comprising, after producing the active plate, coating the higher regions (72) with an increased affinity layer (74) for providing an increased affinity for the polymerizable material of the optical layer, and wherein exposing the optical layer to a stimulus also forms side layers (11) over the increased affinity layer (74).

6. A method as claimed in claim 5, wherein the coating method comprises stamping the increased affinity layer onto the active plate.

7. A method as claimed in claim 6, wherein the stamping is carried out using a non-patterned stamp.

8. A method as claimed in claim 6, wherein the stamping is carried out using a patterned stamp (80).

9. A method as claimed in claim 5, wherein the high affinity layer (74) comprises a layer functionalized with chemically reactive groups.

10. A method as claimed in claim 2, wherein the display pixel cells are enclosed by the passivation layer (50) side walls, the active plate and the polymer surface layer (9).

11. A method as claimed in claim 2, wherein the array of wells (50) is further defined into a photoresist layer (90) on top of the passivation layer (50).

12. A method as claimed in claim 11, wherein the display pixel cells are enclosed by the passivation layer (50) side walls, the active plate, the polymer surface layer (9) and the photoresist layer.

13. A method as claimed in claim 11, wherein the thickness of the resist layer (90) is 5-15 micrometers.

14. A method as claimed in claim 11, wherein the resist layer (90) comprises a material for providing an increased affinity for the polymerizable material of the optical layer.

15. A method as claimed in claim 1, further comprising applying a liquid crystal alignment layer over the active plate.

16. A method as claimed in claim 15, wherein the alignment layer is applied by spincoating.

17. A method as claimed in claim 15, wherein the alignment layer is applied by printing.

18. A method as claimed in claim 1, wherein the electro-optical material comprises a liquid crystal material.

19. An active matrix display device having an optical layer comprising a mixture of an electro-optical material and a polymer precursor, comprising:
an active plate comprising a substrate (60) carrying an array of pixel circuits, each pixel circuit comprising a thin film transistor (32), wherein the active plate comprises a plurality of thin film layers (62,64,66,52,30) defining the transistors, and wherein an upper surface of the active plate comprises a passivation layer (50) in which is defined an array of wells (70) such that the upper surface has higher (72) and lower regions; and
an array of display pixels comprising electro-optical material enclosed between polymerized material (9,11) of the mixture and the active plate, and wherein enclosed bodies of electro-optical material defining display pixels are provided over the lower regions.

20. A device as claimed in claim 19, wherein the passivation layer (50) comprises silicon nitride.

21. A device as claimed in claim 20, wherein the thickness of the silicon nitride layer (50) is 0.5-1.5 micrometers, and the wells (70) comprise at least partially removed areas of the silicon nitride layer.

22. A device as claimed in claim 19, wherein the higher regions (72) are coated with an increased affinity layer (74) for providing an increased affinity for the polymerizable material of the optical layer, and wherein the polymerized material defines side layers (11) over the increased affinity layer (74).

23. A device as claimed in claim 22, wherein the high affinity layer (74) comprises a layer functionalized with chemically reactive groups.

24. A device as claimed in claim 19, wherein the display pixel cells are enclosed by the passivation layer (50) side walls, the active plate and the polymer surface layer (9).

25. A device as claimed in claim 19, wherein the upper surface of the active plate further comprises a photoresist layer (90) on top of the passivation layer (50).

26. A device as claimed in claim 25, wherein the display pixel cells are enclosed by the passivation layer (50) side walls, the active plate, the polymer surface layer (9) and the photoresist layer (90).

27. A device as claimed in claim 25, wherein the thickness of the resist layer (90) is 5-15 micrometers.

28. A device as claimed in claim 25, wherein the resist layer (90) comprises a material for providing an increased affinity for the polymerizable material of the optical layer.

29. A device as claimed in claim 19, further comprising a liquid crystal alignment layer over the active plate.

30. A device as claimed in claim 19, wherein the electro-optical material comprises a liquid crystal material.
